(19) United States
(12) Patent Application Publication
(10) Pub. No.: US 2025/0178855 A1
(43) Pub. Date: Jun. 5, 2025

(54) SUPPLY DEVICE FOR SUPPLYING SEGMENTS OF ENERGY CELLS TO A CELL STACKING DEVICE, AND METHOD FOR SUPPLYING SEGMENTS OF ENERGY CELLS TO A CELL STACKING DEVICE

(71) Applicant: KÖRBER TECHNOLOGIES GMBH, HAMBURG (DE)

(72) Inventor: Karsten MEINKE, MÖLLN (DE)

(21) Appl. No.: 18/842,933

(22) PCT Filed: Mar. 7, 2023
(86) PCT No.: PCT/EP2023/055740

§ 371 Date: Aug. 30, 2024

(30) Foreign Application Priority Data
Mar. 8, 2022 (DE) 102022105400.4

(51) Int. Cl. B65H 35/08; B65H 5/02; H01M 10/04

(52) U.S. Cl. CPC B65H 35/08; B65H 5/021; H01M 10/0404; B65H 2301/121; B65H 2301/351

(57) ABSTRACT

The invention relates to a supply device for supplying segments of energy cells, in particular of a battery cell, to a cell stacking device and to a method for supplying segments of energy cells to a cell stacking device, comprising a supply device which supplies the segments to the cell stacking device in a successive arrangement in a material flow, wherein the supply device supplies the segments to the cell stacking device in a successive arrangement in a material flow, the successive segments are arranged at a respective first distance to one another in the supply device, and the supply device is equipped with a spreading device in which the distance between successive segments in the material flow is increased such that the successive segments have an increased distance to one another in the material flow when supplied to the cell stacking device.

The present invention relates to a supply device for supplying segments of energy cells, in particular of a battery cell, to a cell stacking device having the features of the preamble of claim 1, and to a method for supplying segments of energy cells to a cell stacking device having the features of the preamble of claim 14.

Energy cells or energy storage devices in the sense of the invention are used, for example, in motor vehicles, other land vehicles, ships, aircraft, or in stationary systems such as photovoltaic systems in the form of battery cells or fuel cells, in which very large amounts of energy must be stored over longer periods of time. For this purpose, such energy cells have a structure consisting of a plurality of segments stacked to form a stack.

These segments are each formed from alternating anode sheets and cathode sheets, which are separated from one another by separator sheets that are also produced as segments. The segments are pre-cut in the production process and then placed on top of one another in the predetermined sequence to form the stacks and joined together by lamination. The anode sheets and cathode sheets are first cut from an endless web and then placed individually at intervals on an endless web of separator material. This subsequently formed “double-layer” endless web of separator material with the anode sheets and cathode sheets placed on top is then cut into segments again using a cutting apparatus in a second step, wherein the segments in this case are formed in a double layer by a separator sheet with an anode sheet or cathode sheet arranged on top. If this is technically feasible or necessary from a manufacturing perspective, the endless webs of separator material with the anode sheets and cathode sheets placed on top of one another can also be placed on top of one another before cutting, so that an endless web is formed with a first continuous layer of separator material with anode sheets or cathode sheets placed on top thereof and a second continuous layer of separator material with anode sheets or cathode sheets placed on top thereof. This “four-layer” endless web is then cut into segments by means of a cutting apparatus, which segments in this case are formed in four layers with a first separator sheet, an anode sheet, a second separator sheet, and a cathode sheet lying on top thereof. The advantage of this solution is that one cut can be omitted.

Segments in the sense of this invention are therefore single-layer segments of a separator material, anode material or cathode material, double-layer or even four-layer segments of the structure described above.

Apparatuses for producing battery cells are known, for example, from WO 2016/041713 A1 and DE 10 2017 216 213 A1.

The production of battery cells, e.g., for electromobility, is now carried out on production systems with an output of 100 to 240 monocells per minute. These work in partial regions or continuously with timed, discontinuous movements, such as back and forth movements, and are therefore limited in terms of production output. The majority of known machines work in the single-sheet stacking process (e.g., “pick and place”), with the disadvantage of slower processing. Lamination of cell formations is not possible here.

Another well-known approach is a machine with continuously running material webs and clocked tools, such as cutting knives and tools for changing the pitch.

In principle, machines with clocked movements are limited in terms of performance. The parts with mass, such as holders and tools, must be constantly accelerated and decelerated. The processes determine the timing, and a lot of energy is consumed. The mass of the moving parts cannot be reduced arbitrarily. Faster moving parts often have to endure higher loads and therefore become more complex and heavier.

In order to reduce the production costs of energy cell production, the production output of the machines must, among other things, be increased. A prerequisite for high production output is a high production rate of the stacks of energy cells, which are formed from a plurality of segments stacked on top of one another as described above.

In order to achieve very high production rates, it is desirable to cut the segments from an endless web at the highest possible piece rate during production, for which purpose the endless web must be supplied at a correspondingly high supply speed, and the segments must be cut from the endless web at the highest possible cutting frequency. The segments must then be stacked on top of one another to form stacks. One problem that needs to be solved is that the stacking process and the continuous supply of the segments must be coordinated to allow uninterrupted supply and stacking of the segments at the desired high transport rate.

Against this background, the invention is based upon the object of providing a supply device and a method for supplying segments for energy cells to a cell stacking system, which shall allow the segments to be supplied at a high transport rate while simultaneously simplifying the coordination and synchronization of the stacking process in a cell stacking system.

In order to achieve the object, a supply device having the features of claim 1 and a method having the features of claim 14 are proposed. Further preferred embodiments of the invention can be found in the dependent claims, the figures, and the associated description.

According to the basic concept of the invention, it is proposed according to claim 1 and claim 14 that the supply device be equipped with a spreading device in which the distance between successive segments in the material flow is increased such that the successive segments are at an increased distance from one another in the material flow when supplied to the cell stacking device. The spreading device increases the distance between the segments, which in turn generally simplifies the coordination and synchronization of the stacking process in the cell stacking device. In order to achieve the high conveying rate in the supply device, the segments can be guided at smaller distances from or even in direct contact with one another in the supply device, since the increase in distance is only brought about by the spreading device provided in the supply device itself. Furthermore, in addition to the simplified stacking process in the cell stacking device, the segments can also be divided into two or more parallel transport paths, e.g., by means of a switch, as a result of their increased distances and then stacked in the cell stacking device in a plurality of parallel cell stacking apparatuses. Furthermore, as a result of the increased distances, the movements of the stacking processes in the cell stacking device can be easily coordinated and synchronized with the supply movement of the endless web and the segments after cutting.

The supply device can preferably be formed by a drum run, which allows a very high conveying rate of the segments both in their immediate vicinity or at very small distances.

The spreading device can preferably be formed by at least a first and a second drum of the drum run, wherein the segments are handed over from a lateral surface of the first drum to a lateral surface of the second drum, and the first drum hands over the segments at a first circumferential speed of its lateral surface, and the second drum takes over the segments at a second circumferential speed of its lateral surface, and the second circumferential speed is greater than the first circumferential speed. During the handover from the first drum to the second drum, the segments are practically pulled apart by the higher circumferential speed of the second drum and are transported further at the increased distances. The higher circumferential speed of the second drum is also necessary because the segments are pulled apart by the increase in distance to form a chain of segments with a greater length, which, however, must be discharged in the same time interval in which the same number of segments were previously supplied at the smaller distances.

The handover from the first to the second drum can be simplified by providing a transfer drum between the first and the second drum, and driving the transfer drum to a pulsating rotational speed with alternating acceleration and deceleration between the first circumferential speed and the second circumferential speed, wherein the transfer drum takes over the segments from the first drum at the first circumferential speed and hands over the segments to the second drum at the second circumferential speed. The transfer drum accelerates the segments in the handover from the first drum to the second drum to the higher second circumferential speed, so that they are taken over by the second drum at the higher circumferential speed without slipping.

It is further proposed that the transfer drum have at least two, preferably three, transfer dies. The transfer dies serve to receive and transport the segments on the transfer drum. By providing at least two, preferably three, transfer dies, the handover rate of the segments through the transfer drum can be increased. In particular, this makes it possible to reduce the required rotational speed of the transfer drum to achieve a predetermined handover rate of the segments.

It is further proposed that the first drum have a first radius and the second drum have a second radius, and the second radius be larger than the first radius. By means of the proposed dimensioning of the radii of the drums, the different circumferential speeds of the drums can be realized with the smallest possible rotational speed differences between the drums, wherein the rotational speeds of the drums can even be identical according to a further preferred embodiment of the invention.

Furthermore, the spreading device can also be formed by at least one pitch change drum integrated into the drum run, and the pitch change drum can have a plurality of transport segments arranged on the circumference, each for transporting one segment of the material flow, wherein the transport segments are movable in the radial direction and/or circumferential direction of the pitch change drum, and the segments are moved from the takeover point to the handover point from a smaller radius to a larger radius and/or in the circumferential direction. The proposed pitch change drum allows the distance to be increased on a rotating drum itself. The increase in the distance between the segments is caused by the transport segments and their movement, in that the segments held on the transport segments are moved by the transport segments themselves into an alignment at an increased distance from one another.

It is further proposed that at least two pitch change drums arranged in series be provided in the drum run. By providing at least one further pitch change drum, the distance increase carried out on a pitch change drum can be reduced compared to a distance increase to be realized by a factor corresponding to the number of pitch change drums. This in turn makes it possible to reduce the required relative speeds of the transport segments and the associated accelerations of the transport segments and the segments held thereon to the pitch change drum, which in turn leads to lower transverse forces acting upon the segments during the distance increase.

The pitch change drum can preferably increase the distance between successive segments in the material flow by at least 10 mm, preferably by 13 mm.

It is further proposed that the spreading device be formed by a belt transport device integrated into the drum run, and that the belt transport device comprise an endless belt driven for a transport movement at a first speed, and the first speed be greater than the speed of the supplied segments. The belt transport device increases the distances between the segments by transporting them away from the supply at the first higher speed than in the supply. The belt transport device thereby distorts the segments in the direction of their transport to form a series with larger distances. The direction in which the segments are transported away is determined by the orientation of the endless belt, which can be formed, for example, by a flat orientation of the endless belt and a resulting linear direction of the removal transport.

It is further proposed that the spreading device be formed by a combination, integrated into the drum run, comprising a cutting drum driven to rotate and having a plurality of cutting edges, arranged on the circumferential surface, and a counter drum driven to rotate or also stationary and having at least one counter edge, and the segments of an endless web supplied to the cutting drum at a first speed be cut to a predetermined length by the counter edge of the counter drum sliding against the cutting edges of the cutting drum, and the cutting drum be driven to rotate at a circumferential speed of the lateral surface which is greater than the first speed of the supplied endless web. The cutting drum, together with the counter drum, forms a cutting device in which the segments are cut from the endless web in a predetermined length or width. The cutting drum simultaneously serves to transport the endless web and the discharged segments. Since the circumferential speed of the cutting drum is greater than the speed of the supplied endless web, the segments are actively transported away from the endless web by a shorter distance after cutting, so that the cut end of the segment is then at a distance from the beginning of the next segment. After cutting, the segments are drawn into a series with increased distances.

The invention is explained below using preferred embodiments with reference to the accompanying figures, in which:

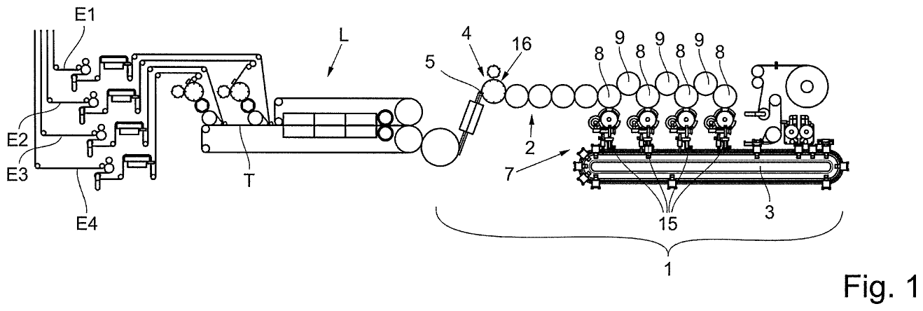

FIG. 1 shows a production machine having a cell stacking system with a supply device, a cell stacking device, and a discharge device; and

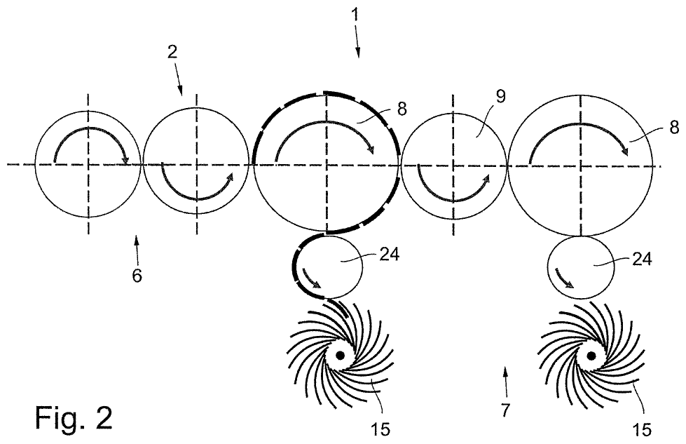

FIG. 2 shows a drum run having two successively arranged pitch change drums and two compartment wheels with a supply via two handover drums; and

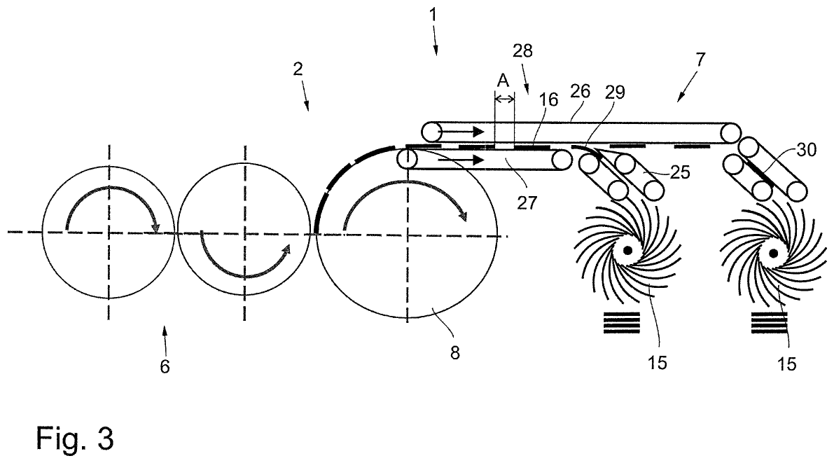

FIG. 3 shows a drum run having two successively arranged pitch change drums and two compartment wheels with a supply of the segments via two endless belts; and

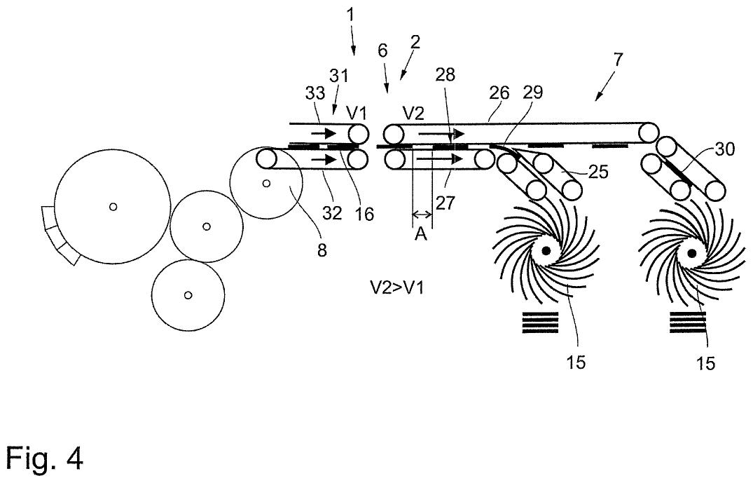

FIG. 4 shows a drum run having two compartment wheels and a supply of the segments via two endless belts and a belt transport device that increases the distances between the segments; and

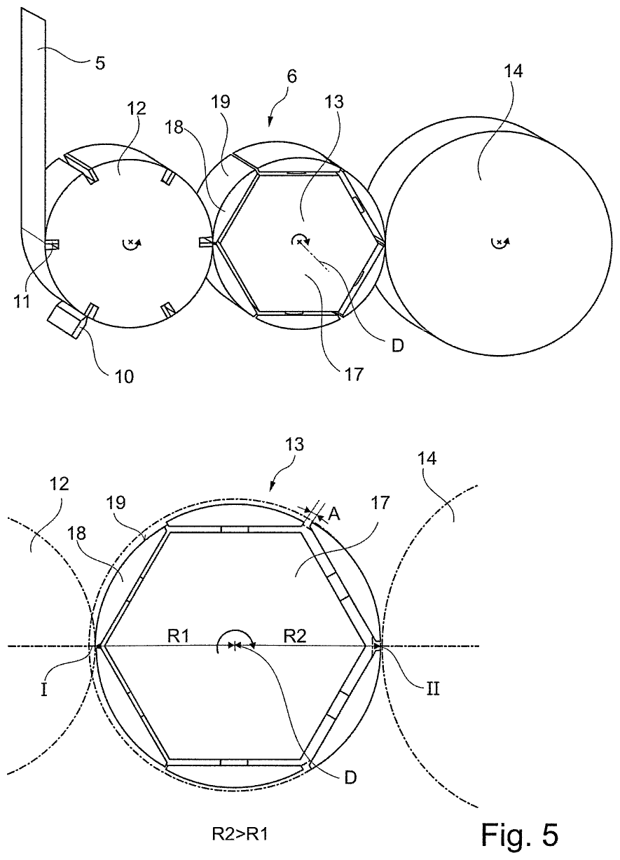

FIG. 5 is an enlarged view of a spreading device formed by a pitch change drum having radially movable transport segments; and

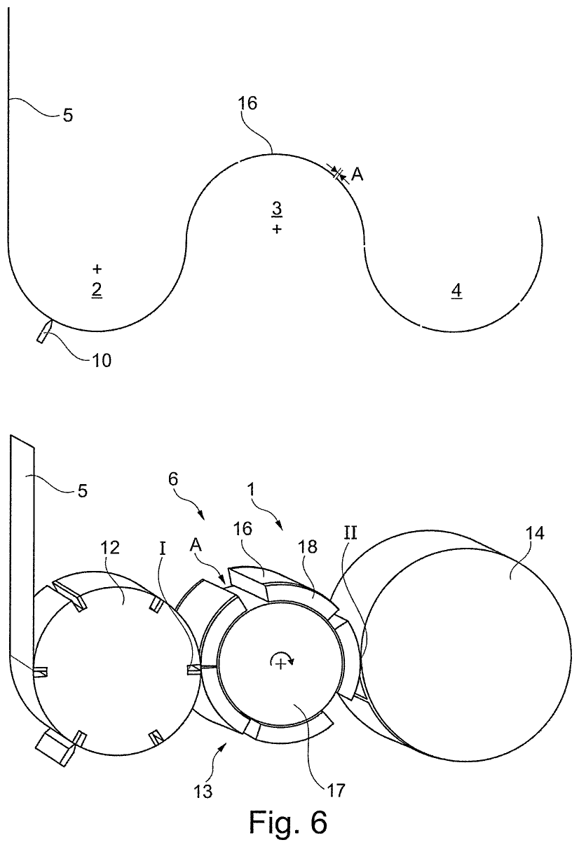

FIG. 6 is an enlarged view of a spreading device formed by a pitch change drum having transport segments movable in the circumferential direction; and

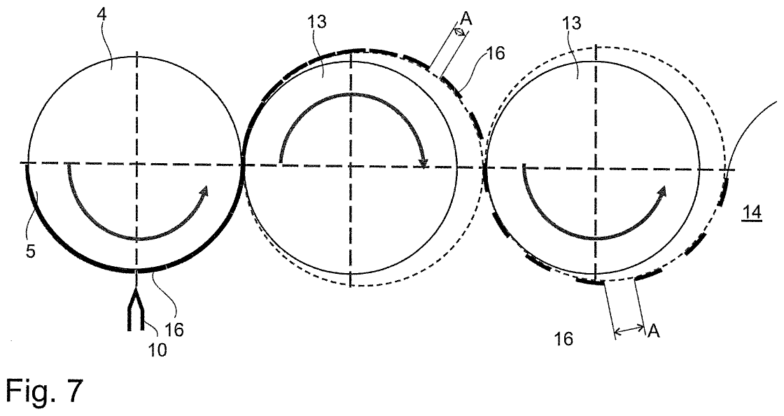

FIG. 7 shows the increase in distance between the segments on the pitch change drums having the radially moving transport segments; and

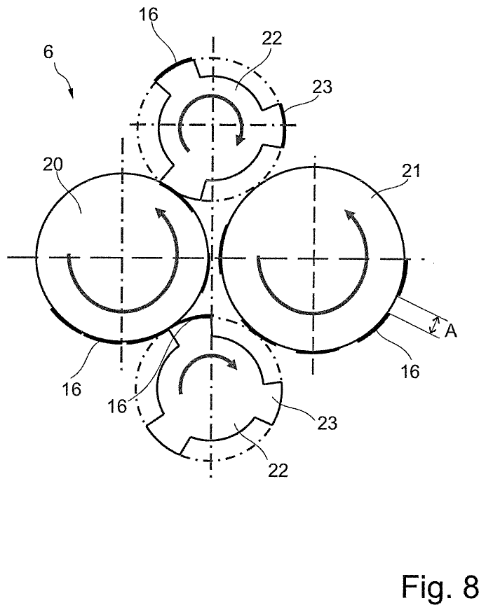

FIG. 8 is an enlarged view of a spreading device having two transport drums with different circumferential speeds and two transfer drums arranged between them; and

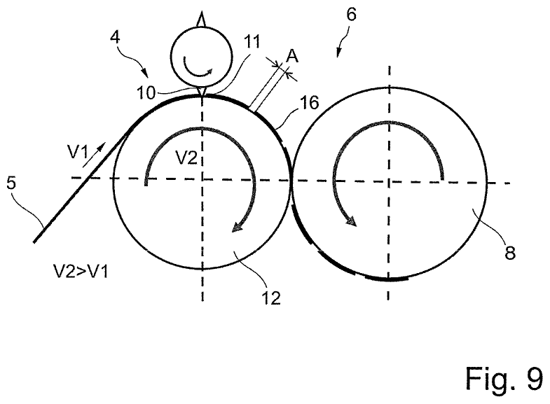

FIG. 9 is an enlarged view of a spreading device formed by a cutting device having a cutting drum and a counter drum.

FIG. 1 shows a production machine having a cell stacking system 1, a supply device 2, a discharge device 3, and a cell stacking device 7 arranged between the supply device 2 and the discharge device 3. The supply device 2 further comprises a cutting device 4 on its inlet side. Furthermore, the production machine comprises a supply of four endless webs E1-E4, wherein two of the endless webs E1 and E3 are formed from a separator material, one endless web E2 from an anode material, and one endless web E4 from a cathode material. The endless webs E2 and E4 of the cathode material and the anode material respectively are cut by means of a cutting device into anodes and cathodes of a predetermined length or width, which are then placed on one of the endless webs E1 and E3 of the separator material after cutting. The merging is carried out by first placing the anodes or cathodes cut off from the lowest endless web E4 individually on a conveyor belt T, then placing the endless web E3 of the separator material above it, and then again placing the anodes or cathodes cut off from the endless web E2 individually on the endless web E3 of the separator material, which are then covered by placing the uppermost endless web E1 of the separator material on the top. This four-layer endless web with the anodes or cathodes on an upper side is then supplied to a lamination unit L, in which they are joined together to form a solid composite by thermal and/or mechanical energy.

The laminated, four-layer endless web 5 is then supplied to the production machine of the cell stacking system 1 and cut into segments 16 of a predetermined length or width, which are also referred to as monocells, in the cutting device 4 of the supply device 2. However, it is also conceivable to supply the cell stacking system 1 in the production machine with double-layer segments 16 consisting of only one layer of a separator material and an anode or cathode, or even single-layer segments 16, provided that these are to be further processed in a stacked manner. In the supply device 2, the segments 16 are further supplied via a plurality of handover drums 8 and reversing drums 9 to various cell stacking apparatuses 15 of the cell stacking device 7, where they are stacked on top of one another and discharged in stack form via the discharge device.

The cutting device 4 is here formed by a pair of drums consisting of a cutting drum having cutting knives 10, which can be seen in FIGS. 5 and 6, and a counter drum 12 having counter knives 11, and cuts the four-layer endless web E guided onto the cutting drum or the counter drum 12 by shearing the cutting knives 10 on the counter knives 11 into segments 16 of a predetermined length, which is defined by the distances between the cutting knives 10 or the counter knives 11, depending upon whether the endless web E is guided onto the cutting drum or the counter drum 12. Starting from the cutting device 4, the cut segments 16 are supplied to a spreading device 6 in the supply device 2. The supply device 2 comprises a drum run having a plurality of transport drums on which the segments 16 are held—for example, by negative pressure. If the supplied endless web E is a four-layer web, the segments 16 cut therefrom correspond to the monocells described above. The segments 16 are used to produce energy cells or energy storage devices, which are used, for example, in land vehicles, ships, aircraft, or stationary devices such as photovoltaic systems and which serve to store and/or convert electrical energy. Energy stored therein can be used, for example, to operate electric drive units, which can, for example, be motor vehicles with an electric drive.

FIG. 2 shows a cell stacking system 1 having a supply device 2, two handover drums 8, a reversing drum 6, and a cell stacking device 7 having two cell stacking apparatuses 15 each in the form of a compartment drum. Between the handover drums 8 and the cell stacking apparatuses 15, an insertion drum 24 is provided, which takes over the segments 16 from the handover drums 8 and hands them over to the compartment drums. Furthermore, a spreading device 6 is integrated into the supply device 2, and can be formed, for example, by one or more pitch change drums 13 according to FIG. 5 or 6, by two transport drums 22 according to FIG. 8, or by a counter drum 12 of the cutting device 4 of FIG. 9 driven at a higher speed V2 relative to a speed V1 of the supplied endless web 5.

The compartment drums are formed by a multitude of side walls, extending spirally from the center to the outside, which form compartments that are open towards the outside. Due to the spiral shape of the side walls, the compartments are opened tangentially in the circumferential direction, so that the segments 16 are inserted tangentially into the compartments of the compartment wheel by the insertion drums 24 in a discharging movement directed in the circumferential direction. During this insertion movement, the compartment wheels perform a continuous rotational movement, by means of which the segments 16 are transported away, and free compartments are moved into the takeover position to receive the subsequent segments 16. The discharge of the segments 16 takes place by moving the segments 16 tangentially out of the compartments of the compartment wheel, wherein the dispensing movement can be consciously supported by the direction of the compartments and the inertial forces acting upon the segments 16.

The stacking of the segments 16 by means of compartment wheels can be carried out in parallel by dividing the segments 16 supplied from the first to the left handover drum 8 in the illustration of FIG. 2 into two material flows, e.g., by handing over every second segment 16 to the reversing drum 9 and guiding it to the further handover drum 8, from which they are then discharged into the second compartment wheel via an insertion drum 24 using the same principle. The segments 16 not handed over to the reversing drum 9 are then discharged parallel to the first compartment wheel, as described above. Alternatively, the segments 16 can also be alternately discharged in their entirety to one of the compartment wheels and stacked on top thereof, so that, during the stacking of the segments 16, the stack previously built up by the other compartment wheel can be transported away via one compartment wheel, and the other compartment wheel can be put back into the state for stacking a new stack.

FIG. 3 shows an alternative embodiment to FIG. 2, the supply device 2 up to the handover drum 8 being identical to the embodiment shown in FIG. 2. However, the embodiment differs in the further transport of the segments 16 from the handover drum 8, in that two, driven endless belts 26 and 27 running one above the other are provided, between which the segments 16 are introduced from the handover drum 8 at their increased distances A from one another. The endless belts 26 and 27 here form a first belt transport device 28, which transports the segments 16 away from the handover drum 8 and supplies them to the cell stacking device 7. The segments 16 are then, via a switch 29, either diverted to a second belt transport device 25 or transported further to a third belt transport device 30 without diversion. The segments 16 are then supplied by the second belt transport device 25 and the third belt transport device 30 to a cell stacking apparatus 15 in the form of a compartment wheel of the type described above. The switch 29 can supply the segments 16 alternately to the second and third belt transport devices 25 and 30, so that the segments 16 are stacked parallel to one another via the compartment wheels. Alternatively, the segments 16 can also be supplied in groups via one of the two belt transport devices 25 or 30 to only one of the compartment wheels, wherein the switch 29 supplies the segments 16 to the other belt transport device and thus to the other compartment wheel when the predetermined number of segments 16 has been supplied to a compartment wheel and stacked on top thereof. In the meantime, the previously formed stack can be discharged.

FIG. 4 shows a further embodiment of the invention, in which a spreading device 6 in the form of a fourth belt transport device 31 and a first belt transport device 28 is provided in the supply device 2. The fourth belt transport device 31 comprises two, driven endless belts 32 and 33, which are arranged opposite one another and enclose a transport channel between them for transporting the segments 16. The supply device 2 comprises a drum run having a handover drum 8, in which various inspection devices and ejection devices for inspecting the segments 16 and ejecting the defective segments 16 can be provided. The embodiment of FIG. 4 differs from the embodiment of FIG. 3 in that the segments 16 are still handed over from the handover drum 8 at small distances, and the increase in the distances A takes place only during the subsequent transport of the segments 16. For this purpose, the fourth belt transport device 31 is provided, which transports the segments 16 away from the handover drum 8 at a first speed V1. The first belt transport device 28 arranged downstream takes over the segments 16 from the fourth belt transport device 31 and transports them further at a higher speed V2, whereby the distances A between the segments 16 are increased. The distance between the fourth belt transport device 31 and the first belt transport device 28 is selected in conjunction with the first speed V1 such that the segments 16 briefly rest against both belt transport devices 31 and 28 during the handover from the fourth belt transport device 31 to the first belt transport device 28, and are thus in effect actively transported away from the fourth belt transport device 31 as a result of the higher speed V2 of the first belt transport device 28. The segments 16 are in effect carried along by the first belt transport device 28. Alternatively, the distance between the two belt transport devices 31 and 28 can also be selected such that the first speed V1 is sufficient to transport the segments 16 completely from the fourth belt transport device 31 to the first belt transport device 28, so that the first belt transport device 28 only transports the segments 16 away at the higher speed V2 when the segments 16 are no longer transported by the fourth belt transport device 31.

FIG. 5 shows a further possible embodiment of the supply device 2 having the cutting device 4 and the spreading device 6, in which the spreading device 6 is formed by a pitch change drum 13, as can be provided, for example, in the supply devices 2 of the embodiments of FIG. 2 or 3.

The endless web 5 is supplied to the cutting device 4, which is designed here as a counter drum 12 having a plurality of counter knives 11 and cutting knives 10 directed towards the circumference of the counter drum 12. The endless web 5 is gripped by the counter drum 12 of the cutting device 4 in a rotational transport movement and supplied further to the pitch change drum 13. The endless web 5 is cut on the cutting device 4 by means of the cutting knives 10 by shearing on the counter knives 11 of the counter drum 12 into segments 16 with a predetermined length. After the endless web 5 has been cut, the segments 16 lie against the outer surface of the counter drum 12 and are held against the outer surface of the counter drum 12—for example, by means of negative pressure. Furthermore, the segments 16 lie directly against one another, i.e., at no distance or at only a very small distance of, for instance, 1 mm, and are only separated from one another by the separating cuts. The segments 16 are then transported on the counter drum 12 by the rotational movement to a takeover point I and are taken over by the pitch change drum 13 at the takeover point I.

Alternatively, instead of the counter drum 12, a cutting device 4 can be used, in which the endless web 5 and/or the segments 16 are cut and supplied to the pitch change drum 13 in a straight, i.e., flat, supply movement. Furthermore, the cutting device 4 can also comprise any curved or deflected supply movement in order to realize different guide paths of the endless web 5 or the segments 16; it is only important that the already cut segments 16 are supplied into the takeover point I in a direct or as close as possible arrangement to one another.

The pitch change drum 13 comprises a drum base body 17 and a plurality of transport segments 18 arranged radially on the outside of the drum base body 17, as can also be seen in the enlarged lower illustration of FIG. 5. The pitch change drum 13 is driven to rotate clockwise in the direction of the arrow by a drive device (not shown) which is in a rotational connection with the drum base body 17. For this purpose, an electric motor can be provided as the drive device, which drives the drum base body 17 directly or via a gear. The transport segments 18 are held in a radially movable manner on the drum base body 17 and each have a curved surface on their outside with a radius that is identical relative to the axis of rotation D of the drum base body 17, so that, in the position pulled towards the drum base body 17, they form in cross-section a circular, cylindrical lateral surface of the pitch change drum 13 with a radius R1. The transport segments 18 have on their radial outer side a takeover surface 19 with a length, directed in the circumferential direction of the pitch change drum 13, which corresponds to the length of the segments 16 cut off from the endless web 5. The transport segments 18 can be provided with compressed air openings in the region of their takeover surfaces 19, which can be subjected to negative pressure in order to take over and hold the segments 6.

Furthermore, a control device (not shown) is provided which controls the movement of the transport segments 18, explained in more detail below, during the circulation from the takeover point I to a handover point II. The control device can be a control cam which is stationary relative to the rotating drum base body 17 and against which the transport segments 18 each rest with a control projection (not shown). Alternatively or additionally, the movement of the transport segments 18 can also be controlled with actuators by an electrical control.

The movement of the transport segments 18 relative to the drum base body 17 is controlled such that the transport segments 18 are pulled towards the drum base body 17 when passing through the takeover point I and thereby lie against one another in the circumferential direction at a very small distance, preferably directly. The radius of the outer surface of the transport segments 18 at the takeover point I corresponds to the radius R1. The cut segments 16 are supplied into the takeover point I in an arrangement directly adjacent to one another or in an arrangement at very small distances from the cutting device 4, and are taken over by the transport segments 18 of the pitch change drum 13. The rotational movement of the pitch change drum 13 and the movement of the transport segments 18 relative to the supply movement of the cutting device 4—in this case relative to the rotational movement of the counter drum 12—are synchronized in such a way that the separating cuts between the segments 16 and the separating points of the transport segments 18 ideally coincide at the takeover point I, so that one segment 16 is taken over by one transport segment 18 at a time. Starting from the takeover point I, the transport segments 18 are extended radially outwards during the further rotational movement of the pitch change drum 13. The distances A between the transport segments 18 and the segments 16 held thereon are increased. The segments 16 are thereby in effect pulled apart and separated. The spaced segments 16 are then taken over and transported away by a subsequent takeover apparatus 14 at the handover point Il on a larger radius R2 at increased distances A. The takeover apparatus 14 is designed here as a transport drum, which in turn is driven to rotate in a direction opposite to the direction of rotation of the pitch change drum 13. However, it is also conceivable to provide as the transfer apparatus 14 an apparatus in which the separated and spaced segments 16 are discharged in a flat or otherwise curved movement path. In principle, when designing the cutting device 4 and the takeover apparatus 14, any desired movement paths can be provided, which can be individually adapted to the geometric specifications of the higher-level system.

FIG. 6 shows an alternative embodiment of the pitch change drum 13, in which the transport segments 18 of the pitch change drum 13 are not moved in the radial direction, but instead in the circumferential direction, of the drum base body 17. The transport segments 18 are accelerated from the takeover point I in the direction of rotation of the drum base body 17, whereby the distances A between the transport segments 18 and between the segments 16 held thereon are increased. The segments 16 are thus handed over from the cutting device 4 to the pitch change drum 13 at the takeover point I, in the same way as in the exemplary embodiment of FIG. 1, at a very small distance or in an arrangement directly adjacent to one another, and are handed over to the takeover apparatus 14 at the handover point Il in an arrangement with increased distances A, preferably at a speed at the handover point Il that is increased or the same relative to the speed at the takeover point I. In order that the transport segments 18, after passing through the handover point II, be again in contact with one another at smaller distances or directly adjacent to one another at the takeover point I, they are decelerated again in relation to the rotational movement of the drum base body 17 after the segments 16 have been handed over to the takeover apparatus 14, whereby the distances A are reduced again until the takeover point I is reached.

Both movement sequences of the transport segments 18 shown in FIGS. 5 and 6 lead to an increase in the distances A between the transport segments 18 themselves and the segments 16 transported on the transport segments 18, as described above. Of course, the movement sequences can also be combined if, for example, the distance increase is to be made even larger or if more favorable conditions for the handover of segments 6 at the handover point Il can be achieved.

In FIG. 7, the endless web 5 and the segments 16 cut off therefrom can be seen in isolation. The endless web 5 is supplied to the cutting device 4 and cut in the cutting device 4. The segments 16 in the cutting device 4 are still in direct contact with one another, which is why no distances can yet be seen here. Only after the segments 16 have been taken over from the pitch change drum 13 are the distances A between the segments 16 increased until the segments 16 with their increased distances A are handed over to another pitch change drum 13, in which the distances A are increased again until they are finally taken over by the takeover device 14. The distances A are thus increased step by step in the pitch change drums 13, wherein each of the pitch change drums increases the distance A of the segments 16 by at least 10 mm, preferably by 13 mm, so that the segments 16 are finally handed over to the takeover device 14 at a distance of 27 mm, taking into account an initial distance A of 1 mm.

FIG. 7 shows a further spreading device 6, which comprises a first drum 20 and a second drum 21, as well as two transfer drums 22 arranged between them. The spreading device 6 is therefore preferably suitable for integration into a supply device 2 with a drum run, as provided in FIGS. 2 and 3. The first drum 20 and the second drum 21 are driven to rotate at different circumferential speeds of the lateral surfaces on which the segments 16 are held. The lateral surface of the second drum 21 has a higher circumferential speed than the lateral surface of the first drum 20. These different circumferential speeds can be achieved by different radii of the two drums 20 and 21 and/or different rotational speeds of the drums 20 and 21. The different circumferential speeds can also be achieved by the drums 20 and 21 having identical rotational speeds and the second drum 21 having a larger radius than the first drum 20. Furthermore, the two drums 20 and 21 can also have identical radii and thus be designed identically, wherein the second drum 21 in this case is driven at a higher rotational speed than the first drum 20.

Between the two drums 20 and 21, two transfer drums 22, each with three transfer dies 23, are provided, which are driven to a pulsating rotational movement and take over the segments 16 with their transfer dies 23 from the first drum 20 at the lower circumferential speed, and hand them over to the second drum 21 at the higher circumferential speed. The transfer drums 22 are each driven to pulsating rotational movements between the lower circumferential speed of the first drum 20 and the higher circumferential speed of the second drum 21, wherein the directions of rotation of the transfer drums 22 are opposite to the directions of rotation of the first and second drums 20 and 21.

The transfer drums 22 thus in effect form an interface between the first drum 20 rotating at the lower circumferential speed and the second drum 21 rotating at the higher circumferential speed and, as a result of their pulsating rotational drive movement, allow the segments 16 to be taken over from the first drum 20 and handed over to the second drum 21 with as little slippage as possible, despite the different circumferential speeds of the two drums 20 and 21. After being taken over from the first drum 20 with the transfer dies 23, the segments 16 are accelerated by the swelling rotational drive movement of the transfer drum 22 until they are handed over to the second drum and are then decelerated again to take over a segment 16. The transfer drums 22 are accelerated and decelerated during one revolution in a number of acceleration and deceleration processes corresponding to the number of transfer dies 23. A further advantage of the transfer drums 22 is that the segments 16 are turned over once during the handover from the first to the second drum 20, 21 and are thus held in the same orientation on the drums 20 and 21. Furthermore, the transfer drums 22, by taking over and handing over the segments 16 between them, allow the two drums 20 and 21 to rotate in the same direction. This can simplify the further transport and/or stacking of the segments 16 overall.

FIG. 9 shows a further embodiment of a spreading device 6 that can be integrated into a drum run and in which the endless web 5 is guided onto a counter drum 12 of a cutting device 4 and is cut there, as described above, into segments 16 of a predetermined length by the cutting blades 10 sliding along the counter blades 11 of the counter drum 12. In this case, the spreading device 6 is implemented by driving the counter drum 12 to a rotational speed with a circumferential speed V2 of the lateral surface, which is greater than the supply speed V1 of the endless web 5. As a result, the segments 16 are pulled apart after cutting on the counter drum 12, increasing their distances A, and are handed over to a handover drum 8 at the increased distances A.

### LIST OF REFERENCE SIGNS

1 Cell stacking system
2 Supply device
3 Discharge device
4 Cutting device
5 Endless web
6 Spreading device
7 Cell stacking device
8 Handover drum
9 Deflection drum
10 Cutting edge
11 Counter edge
12 Counter drum
13 Pitch change drum
14 Takeover apparatus
15 Cell stacking apparatus
16 Segment
17 Drum base body
18 Transport segment
19 Takeover surface
20 First drum
21 Second drum
22 Transfer drum
23 Transfer die
24 Insertion drum
25 Second belt transport device
26 Endless belt
27 Endless belt
28 First belt transport device
29 Switch
30 Third belt transport device
31 Fourth belt transport device
32 Endless belt
33 Endless belt
E1-E4 Endless web
T Conveyor belt
L Lamination unit
A Distance
I Takeover point
II Handover point
D Axis of rotation
R1 Radius
R2 Radius
V1 Speed
V2 Speed

1. A supply device for supplying segments of energy cells to a cell stacking device, wherein
the supply device supplies the segments- to the cell stacking device in a successive arrangement in a material flow, wherein
the successive segments are arranged at a respective first distance to one another in the supply device,
wherein
the supply device is equipped with a spreading device in which the distance between successive segments in the material flow is increased such that the successive segments are at an increased distance from one another in the material flow when supplied to the cell stacking device.

2. The supply device according to claim 1, wherein the supply device is formed by a drum run.

3. The supply device according to claim 2, wherein
the spreading device is formed by at least a first and a second drum of the drum run, wherein
the segments are handed over from a lateral surface of the first drum to a lateral surface of the second drum, and
the first drum hands over the segments at a first circumferential speed of its lateral surface at a takeover point, and
the second drum takes over the segments at a second circumferential speed of its lateral surface, and
the second circumferential speed is greater than the first circumferential speed.

4. The supply device according to claim 3, wherein
a transfer drum is provided between the first and second drums, and
the transfer drum is driven to a pulsating rotational speed with an alternating acceleration and deceleration between the first circumferential speed and the second circumferential speed, and wherein
the transfer drum takes over the segments from the first drum at the first circumferential speed and hands over the segments to the second drum at the second circumferential speed.

5. The supply device according to claim 4, wherein
the transfer drum has at least two transfer dies.

6. The supply device according to claim 3, wherein
the first drum has a first radius and the second drum has a second radius, wherein the second radius is larger than the first radius.

7. The supply device according to claim 6, wherein the first drum and the second drum have the same rotational speed.

8. The supply device according to claim 2, wherein
the spreading device is formed by at least one pitch change drum integrated into the drum run, which
has a plurality of transport segments arranged on the circumference for transporting one segment of the material flow, wherein
the transport segments are movable in the radial direction and/or circumferential direction of the pitch change drum, and
the segments are moved from the takeover point to the handover point from a smaller radius to a larger radius and/or in the circumferential direction.

9. The supply device according to claim 8, wherein
at least two pitch change drums arranged in series are provided in the drum run.

10. The supply device according to claim 8, wherein
the pitch change drum increases the distance between successive segments in the material flow by at least 10 mm.

11. The supply device according to claim 2, wherein
the spreading device is formed by a belt transport device integrated into the drum run, and
the belt transport device comprises an endless belt driven for a transport movement at a first speed, and
the first speed is greater than the speed of the supplied segments.

12. The supply device according to claim 2, wherein
the spreading device is formed by a combination, integrated into the drum run, comprising a cutting drum driven to rotate and having a plurality of cutting edges, arranged on the circumferential surface, and a counter drum driven to rotate or also stationary and having at least one counter edge, and
the segments of an endless web supplied to the cutting drum and/or the counter drum at a first speed are cut to a predetermined length by the counter edge of the counter drum sliding against the cutting edges of the cutting drum, and
the cutting drum is driven to rotate at a circumferential speed of the lateral surface which is greater than the first speed of the supplied endless web.

13. A cell stacking system having a supply device according to claim 1, wherein
a cell stacking device having at least one compartment wheel is provided.

14. Method A method for supplying segments of energy cells to a cell stacking device, comprising:
a supply device which supplies the segments to the cell stacking device in a successive arrangement in a material flow, wherein
the successive segments are arranged at a respective first distance to one another when entering the supply device,
wherein
the supply device has a spreading device in which the distance between successive segments in the material flow is increased such that the successive segments in the material flow at the inlet to the cell stacking device are arranged at a second distance to one another which is greater than the first distance.

15. Method The method according to claim 14, wherein the segments are transported in the supply device in a drum run.

16. The method according to claim 15, wherein
the spreading device is formed by at least a first and a second drum of the drum run,
wherein
the segments are handed over from a lateral surface of the first drum to a lateral surface of the second drum, and
the first drum hands over the segments at a first circumferential speed of its lateral surface at a takeover point, and
the second drum takes over the segments at a second circumferential speed of its lateral surface, and
the second circumferential speed is greater than the first circumferential speed.

17. The method according to claim 16, wherein
a transfer drum is provided between the first and second drums, and
the transfer drum is driven to a pulsating rotational speed with an alternating acceleration and deceleration between the first circumferential speed and the second circumferential speed,
wherein
the transfer drum takes over the segments from the first drum at the first circumferential speed and hands over the segments to the second drum at the second circumferential speed.

18. The method according to claim 17, wherein
the transfer drum has at least two transfer dies.

19. The method according to, claim 16, wherein
the first drum has a first radius and the second drum has a second radius, wherein the second radius is larger than the first radius.

20. The method according to claim 19, wherein
the first drum and the second drum are each driven by a drive device at identical rotational speeds.

21. The method according to claim 15, wherein
the spreading device is formed by at least one pitch change drum integrated into the drum run, and
the pitch change drum has a plurality of transport segments arranged on the circumference, each for one segment of the material flow, wherein
the transport segments are movable in the radial direction and/or circumferential direction of the pitch change drum, and
the segments are moved from a takeover point (I) to a handover point (II) from a smaller radius (R1) to a larger radius (R2) and/or in the circumferential direction.

22. The method according to claim 21, wherein
at least two pitch change drums arranged in series are provided in the drum run.

23. The method according to, claim 21, wherein
the pitch change drum increases the distance between successive segments in the material flow from the takeover point (I) to the handover point (II) by at least 10 mm.

24. The method according to claim 15, wherein
the spreading device is formed by a belt transport device integrated into the drum run, and
the belt transport device comprises an endless belt driven for a transport movement at a first speed, and wherein
the first speed of the belt transport device is greater than the speed of the supplied segments.

25. The method according to claim 15, wherein
the spreading device is formed by a combination, integrated into the drum run, comprising a cutting drum driven to rotate and having a plurality of cutting edges, arranged on the circumferential surface, and a counter drum driven to rotate or stationary and having at least one counter edge, and
the segments of an endless web supplied to the cutting drum and/or the counter drum at a first speed are cut to a predetermined length by the counter edge of the counter drum sliding against the cutting edges of the cutting drum, and
the cutting drum and/or the counter drum is driven to rotate at a circumferential speed of the lateral surface which is greater than the first speed of the supplied endless web.
